(19) United States
(12) Patent Application Publication
(10) Pub. No.: US 2006/0107849 A1
(43) Pub. Date: May 25, 2006

(54) Printing apparatus, data backup method, data file generation method, and program

(75) Inventor: Ryusuke Furuhashi, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(73) Assignee: SONY CORPORATION

(21) Appl. No.: 11/261,291

(22) Filed: Oct. 27, 2005

(30) Foreign Application Priority Data
Nov. 10, 2004 (JP) P2004-325931

(51) Int. Cl. B41L 15/00

(52) U.S. Cl. 101/113

(57) ABSTRACT

A printing apparatus includes a volatile storage device temporarily storing print data; a printing device recording a print image corresponding to the print data on a recording medium; an operation detection section detecting a printing operation for instructing that a printing be performed; and a reproduction control section reproducing print data specified so as to be printed from the volatile storage device to a built-in or externally provided non-volatile storage device by using a detection of the printing operation as a trigger.

### CROSS REFERENCES TO RELATED APPLICATIONS

The present invention contains subject matter related to Japanese Patent Application JP 2004-325931 filed in the Japanese Patent Office on Nov. 10, 2004, the entire contents of which are incorporated herein by reference.

### BACKGROUND OF THE INVENTION

1. Field of the Invention

The present invention relates to a printing apparatus for performing a printing process on the basis of print data that is temporarily stored in a volatile storage device. The present invention relates to a method of backing up print data. The present invention relates to a data file generation method for converting print data into an image data format suitable for display on a display device. The present invention relates to a program for defining a control operation of a computer incorporated in a printing apparatus.

2. Description of the Related Art

At present, for printing apparatuses (hereinafter, referred to also as “printers”), various printing methods are used. These printing methods can be broadly classified into an impact method and a non-impact method. Examples of non-impact methods include a thermal type method, an ink-jet method, and an electrophotographic method.

In a typical printing apparatus, print data is temporarily stored in a volatile storage device (RAM (random access memory)) incorporated in the apparatus, and a print image corresponding to the target print data is recorded on a recording medium. For the recording medium, for example, printing paper and a sheet of material are used.

### SUMMARY OF THE INVENTION

In a printing apparatus having a mechanical mechanism section, a paper jam and other printing troubles may occur. When such a trouble occurs, there are cases in which it is possible to deal with the trouble in a state in which electricity is being supplied. In general, however, there are cases in which switching off of the printing apparatus is needed. For example, for removing a paper jam, the power supply is sometimes switched off.

When the power supply is switched off, print data in the middle of being printed or waiting for being printed, which is stored in a volatile storage device, is erased at the same time. In this case, in a printing apparatus at present, the same print data needs to be received again after the trouble is restored.

However, in the case of nonreproducible data or data for which no storage file exists, the re-capture of the data becomes considerably difficult, or much operation burdens and much operation time become newly necessary. For example, in the case of a diagnostic image captured in real time from a medical device, a patient is forced to undergo a re-examination.

There is another case in which it is desired to print the same print image again after printing. However, print data stored in a volatile storage device is rewritten in an overwriting manner in sequence using another print image. Therefore, when it is desired to print a print image again, it is necessary to capture the corresponding print data. Of course, in the case of nonreproducible data or data for which no storage file exists, the re-capture of the data becomes considerably difficult, or much operation burdens and much operation time become newly necessary.

In addition, when a printing trouble occurs, although the printing job for which the printing process is stopped can be confirmed on the basis of the text base, it is difficult to confirm the print image for which the printing process is stopped.

The inventors of the present invention have taken note of the above technological problems and have proposed the following technological techniques.

According to an embodiment of the present invention, there is provided a printing apparatus including: a volatile storage device temporarily storing print data; a printing device recording a print image corresponding to the print data on a recording medium; an operation detection section detecting a printing operation for instructing that a printing be performed; and a reproduction control section reproducing print data specified so as to be printed from the volatile storage device to a built-in or externally provided non-volatile storage device by using a detection of the printing operation as a trigger.

According to another embodiment of the present invention, there is provided a printing apparatus including: a volatile storage device temporarily storing print data; a printing device recording a print image corresponding to the print data on a recording medium; an operation detection section detecting a printing operation for instructing that a printing be performed; and a data format conversion section converting print data specified so as to be printed into an image data format suitable for display on a display device by using a detection of the printing operation as a trigger.

According to the embodiment of the present invention, print data whose actual printing is started by a printing operation for instructing that a printing be performed, print data waiting for being printed, or print data that is actually printed can be stored in a non-volatile storage device. Therefore, when a printing trouble that does not affect the signal processing system occurs or when a re-printing is performed, a necessary print image can be printed from the non-volatile storage device.

The recording operation for recording print data in the non-volatile storage device is automatically performed by using a printing operation for instructing that a printing be performed as a trigger. Therefore, a special operation for storing print data in a non-volatile storage device is not necessary.

According to the embodiment of the present invention, print data whose actual printing is started by a printing operation, print data waiting for being printed, or print data that is actually printed can be converted into an image data format suitable for display on a display device. Therefore, when a printing trouble occurs and during a follow-up confirmation operation, a special operation is not necessary, and the print image can be confirmed on the display device.

### BRIEF DESCRIPTION OF THE DRAWINGS

FIG. 1 shows an example of the configuration of a printing apparatus;

FIGS. 2A and 2B show examples of the configuration of a printing apparatus corresponding to the connection format of a non-volatile storage device;

FIG. 3 shows an example of the configuration of a function block of a system control section corresponding to a backup processing function;

FIG. 4 is a conceptual view of the flow of data when a print button is operated;

FIG. 5 shows an example of the configuration of a function block of a system control section corresponding to a reprinting function;

FIG. 6 is a conceptual view of the flow of data during a re-printing;

FIG. 7 is a conceptual view of the flow of data during a re-printing;

FIG. 8 shows an example of the configuration of a function block of a system control section corresponding to a data conversion processing function;

FIG. 9 shows an example of a control procedure when a printing is performed;

FIG. 10 shows an example of a control procedure when a re-printing is performed; and

FIG. 11 shows another example of a control procedure when a printing is performed.

### DESCRIPTION OF THE PREFERRED EMBODIMENTS

A description will now be given below of an embodiment of a printing apparatus in which a technological technique according to the present invention is adopted. A well-known or publicly known technology of the target technological field is applied to portions that are not particularly shown in the figures or described in this specification. An embodiment to be described below is one embodiment of the present invention and should not be limited to this embodiment.

(A) Example of Configuration of Printing Apparatus

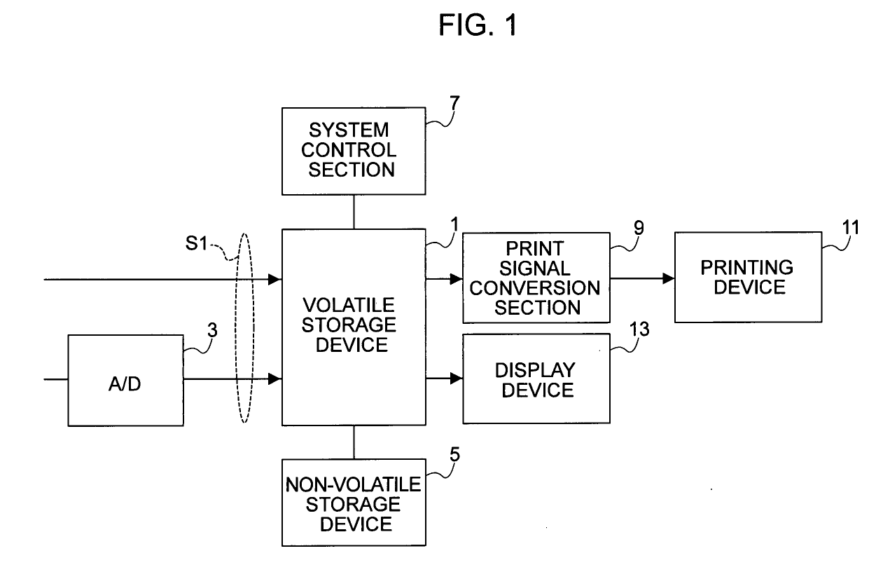

FIG. 1 shows an example of the configuration of a printing apparatus. This printing apparatus includes, as main constituents, a volatile storage device 1, an analog-to-digital conversion circuit 3, a non-volatile storage device 5, a system control section 7, a print signal conversion section 9, a printing device 11, and a display device 13. The configuration specific to this printing apparatus is that, in addition to the volatile storage device 1, the non-volatile storage device 5 is used.

The volatile storage device 1 is a storage device for temporarily storing print data S1. For example, the volatile storage device 1 is formed of a DRAM (dynamic random access memory) or an SRAM (static random access memory). This volatile storage device 1 also includes a driving circuit for controlling reading and writing of the print data S1 from and to a storage area.

The print data S1 is composed of main body data and attachment data. The main body data is composed of the main body of image data and character data. The attachment data is composed of information attached to the main body data. For example, the attachment data is composed of print mode information (screen division print, draft print, high-precision print, etc.), color adjustment information, and number-of-sheets information.

The volatile storage device 1 preferably has a storage capacity capable of storing main body data for one frame or plural frames.

This printing apparatus complies with two types of signal formats as an input format of print information corresponding to the print image. That is, the printing apparatus complies with two types of signal formats, that is, an analog signal format and a digital signal format.

For example, when print information is input in a digital signal format, the input print data S1 is directly written into the volatile storage device 1.

For example, when the print information is input in an analog signal format, that converted into the digital signal format by the analog-to-digital conversion circuit 3 is written into the volatile storage device 1. For inputs in an analog signal format, for example, compatible signals are a composite video signal, an S video signal, and an analog RGB signal.

The non-volatile storage device 5 is a storage device for storing print data S1 (main body data and attachment data) in a saving manner. For example, the non-volatile storage device 5 is formed of a driving device in which an optical disc, a hard disk, or another magnetic disk is used as a storage medium, or a semiconductor memory.

The semiconductor memory may be not only a built-in memory of the printing apparatus but also an external memory that is connected via an external interface. In this embodiment, it is assumed that both a built-in memory and an external memory can be used.

For the non-volatile semiconductor memory, an EEPROM (electrically erasable and programmable read only memory), an MRAM (magnetoresistive random access memory), an FeRAM (ferroelectric random access memory), and an OUM (ovonic unified memory), and other memories are used.

The non-volatile storage device 5 preferably has a storage capacity capable of storing main body data for one frame or plural frames.

The system control section 7 is a processor for realizing in a software manner a processing circuit for providing a function for storing the print data S1 from the volatile storage device 1 to the non-volatile storage device 5 in a saving manner (reproduction function), or equivalent functions.

In the case of this embodiment, the system control section 7 detects the operation of a print button and performs an operation for storing the print data S1.

Here, the operation of the print button is supplied to the system control section 7 via a user interface provided in the printing apparatus or via a user interface of an external device.

For the print button, for example, not only a button, a switch, or another physical operation element, but also an icon displayed on the display screen, and another GUI (Graphical User Interface) are used.

The system control section 7 also provides a function for controlling the overall operation of the system. Furthermore, the system control section 7 also functions as a processor for realizing in a software manner a processing circuit for controlling the restart of a printing process when restoring from a printing trouble, or equivalent functions.

The print signal conversion section 9 is formed of a circuit or a processor for realizing in a software manner an image processing board or equivalent processing functions.

The content of the processing function differs depending on the printing method adopted in the printing device 11. For example, a luminance/density conversion process, a gamma conversion process, and a gradation conversion process are performed.

The printing device 11 is a device for recording a print image corresponding to the print data on a recording medium.

In the printing device, a print head and an optical unit corresponding to a printing method adopted by the printing apparatus are incorporated. Examples of the printing method include a thermal head method (thermal transfer type, thermal type, etc.), an ink-jet method, an electrophotographic method (laser method, LED method, etc.).

The display device 13 is a user interface used to confirm the internal information of the printing apparatus and to input an operation instruction. For example, a liquid-crystal display or another flat display is assumed therefor.

At any rate, the display device 13 may be not only configured integrally with the printing apparatus, but also may be externally connected as an external monitor.

This display device 13 is also used to confirm the print image stored in the non-volatile storage device 5.

In the printing apparatus, as other unillustrated constituents, a mechanism for transporting a print medium (e.g., printing paper, a sheet of material) and a mechanism for driving the printing device are incorporated.

(B) Example of Incorporation or Mounting of Non-volatile Storage Device

As described above, the non-volatile storage device 5 can be incorporated not only as an internal memory of the printing apparatus, but also as an external memory of the printing apparatus.

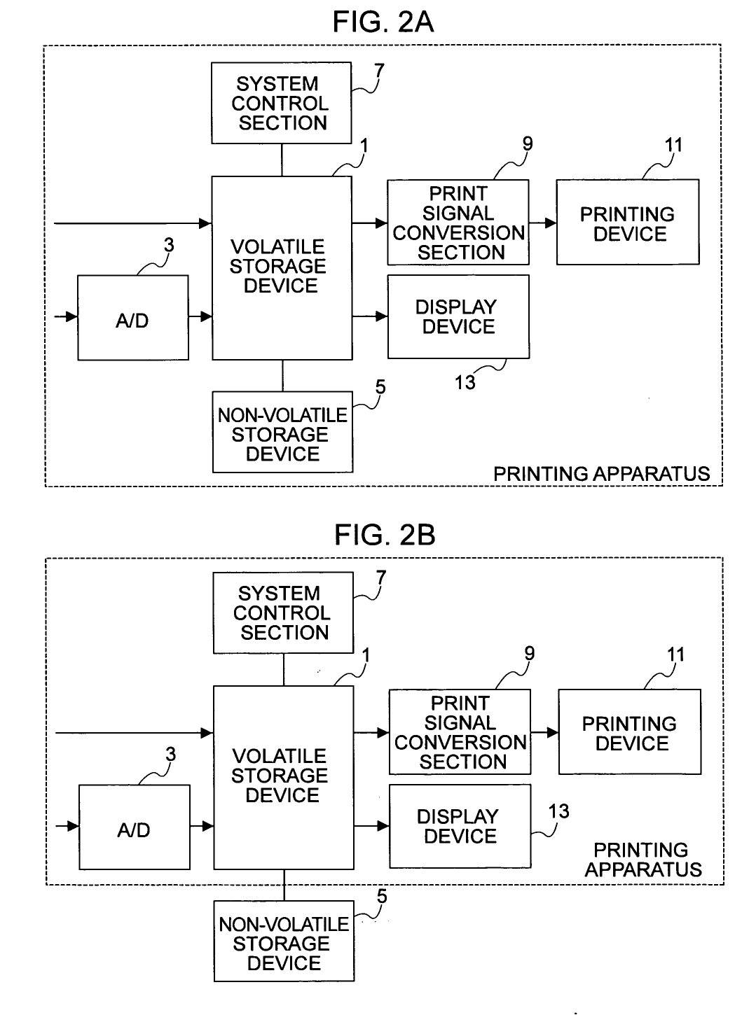

Part (A) of FIG. 2 shows an example of the configuration of a printing apparatus in a form in which the non-volatile storage device 5 is incorporated. Part (B) of FIG. 2 shows an example of the configuration of a printing apparatus in a form in which the non-volatile storage device 5 is mounted as an external memory.

When the non-volatile storage device 5 is externally provided in the printing apparatus, the connection between the driving device corresponding to a recording medium and the printing apparatus may be not only a wire connection, but also may be a wireless connection. The external connection herein includes not only a case in which devices are directly connected to one another but also a case in which these devices are connected via a LAN (local area network).

There can also be a case in which a non-volatile recording medium is loadable into and removable from the driving device. This applies to a case in which, for example, the recording medium is a semiconductor memory or an optical recording medium.

As this type of removable recording medium, a recording medium that takes the form of a rectangular shape, a card shape, and a disc shape is known. Of course, in this case, the driving device may be arranged in the housing of the printing apparatus, and it may also be externally connected via a communication path.

The printing apparatus is not limited to a printing-only device. The printing apparatus can also be applied to a composite machine incorporating a scanner function and a printing function and to a composite machine incorporating a facsimile communication function and a printing function.

(C) Function Structure of System Control Section

Next, a description is given of a processing function specific to the system control section 7. The processing function of the system control section 7 can be broadly classified into a backup processing function in preparation for an occurrence of a trouble and a data conversion function in preparation for secondary use. The function block structure of the system control section 7 corresponding to each processing function is described below.

It is assumed that, in the printing apparatus, at least one type of a backup processing function and a data conversion function are installed. The backup processing function also includes a processing function for recovery.

(C-1) Backup Processing Function

(a) When the Print Button is Operated

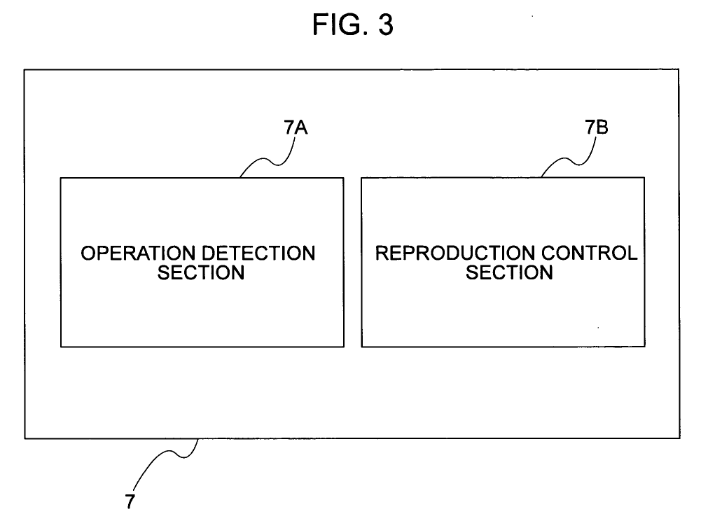

FIG. 3 shows the function block structure of the system control section 7 corresponding to the backup processing function. The system control section 7 implementing this function can be represented as two function blocks of an operation detection section 7A and a reproduction control section 7B.

The operation detection section 7A can be realized as a circuit section or a process for detecting a printing operation for instructing that a printing be performed. This operation detection section 7A detects the operation of the print button. In the case of this example, the operation of the print button is assumed to mean that the specified print image is printed only once.

The reproduction control section 7B can be realized as a circuit section or a process for reproducing print data specified so as to be printed from the volatile storage medium 1 to the built-in non-volatile storage device 5 by using the detection of the printing operation as a trigger. In the case of this example, the reproduction control section 7B automatically performs a reproduction operation in parallel with the reading of print data into the printing device 11.

This function enables only the print data that is actually in the middle of being printed or waiting for being printed to be backed up. This backup process is performed in the background with respect to the printing operation.

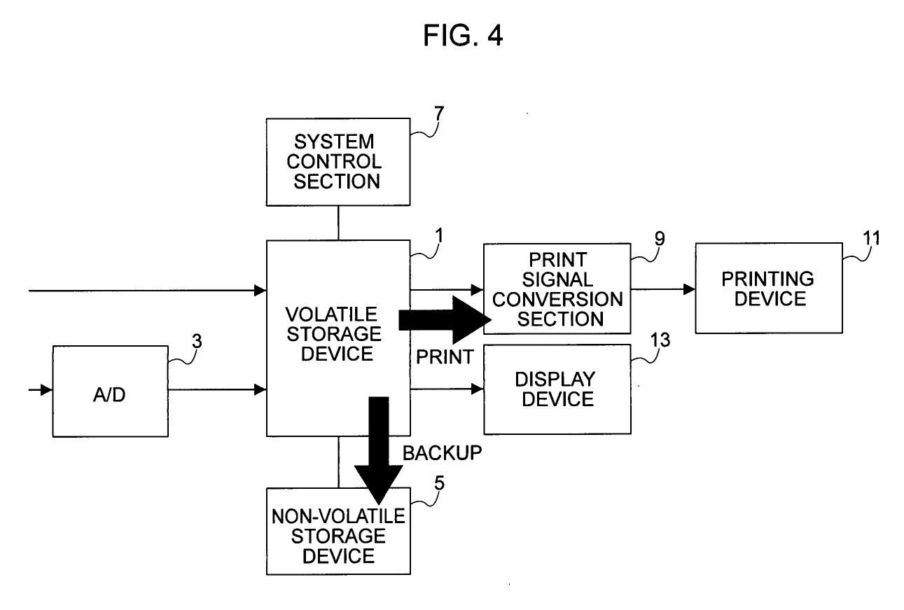

Therefore, the user needs only to be conscious about only the selection of a printing target and the execution of a printing. In order to realize a comparable backup process in the system of the related art, in addition to the operation of the print button, a backup instruction input is necessary. Also, in this point, the number of operations by the user can be reduced. FIG. 4 schematically shows the backup processing function.

The process for receiving print data (capturing process) can be performed also while the print data is being printed (that is, in the middle of backup).

That is, the process for receiving print data in the volatile storage device 1 is performed in the background within the print time. As a result, there is no need for the user to separately perform the process for receiving print data and the process for printing print data. For this reason, the continuous capture of print data becomes possible. In particular, when one scene of a real-time video (live video) is to be captured as print data, the capability of continuous capture is effective.

(b) When a Trouble is Recovered and When a Re-Printing is Performed

Next, a description is given of a processing function performed in the system control section 7 when a trouble is recovered and when a re-printing is performed.

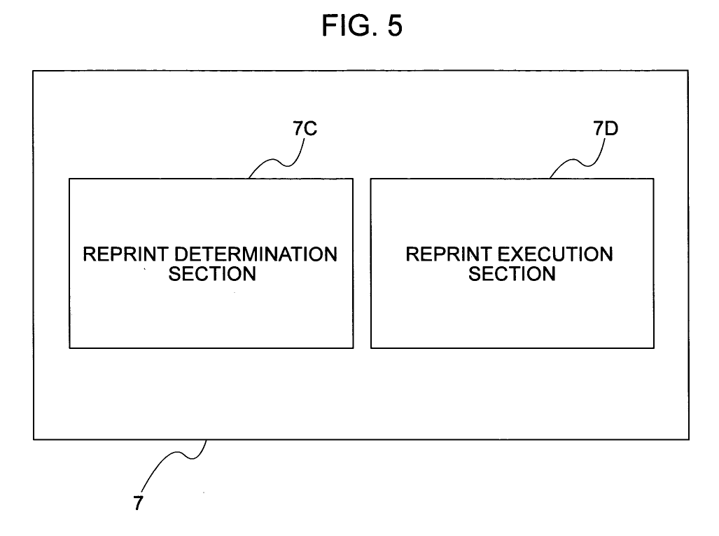

FIG. 5 shows the function block structure of the system control section 7 corresponding to the processing function. The system control section 7 that realizes this function can be represented as two function blocks of a reprint determination section 7C and a reprint execution section 7D.

The reprint determination section 7C realizes two determination functions.

One of the determination functions is performed after the power supply of the printing apparatus is switched on. The switching on of the power supply is performed as an operation following the switching off when a trouble occurs and is also performed for normal use.

Examples of switching off when a trouble occurs include switching off due to a paper jam (not all need switching off) and switching off due to a user operation while a printing is being performed. In all the cases, the printing is terminated in a state in which the printing process is not completed.

The reprint determination section 7C provides this processing function as a circuit section or a process for determining whether or not the print data stored in the non-volatile storage device 5 exists.

When the print data is stored in the non-volatile storage device 5, the reprint determination section 7C determines that print data that can be reprinted exists. In particular, the existence of the print data whose printing is stopped resulting from the occurrence of a trouble is determined on the basis of whether or not a print completion mark is attached to the print data. When the print data to which the print completion mark is attached exists, the reprint determination section 7C determines that reprintable print data exists.

On the other hand, when print data is not stored in the non-volatile storage device 5, the reprint determination section 7C determines that reprintable print data does not exist.

The other determination function is performed at all times. This determination function is performed when the reprint of the print image is instructed by the user. In this case, the reprint determination section 7C functions as a circuit section or a process for determining whether or not the print data stored in the non-volatile storage device 5 exists.

When the print data is stored in the non-volatile storage device 5, the reprint determination section 7C determines that the reprintable print data exists. On the other hand, when print data is not stored in the non-volatile storage device 5, the reprint determination section 7C determines that reprintable print data does not exist.

The reprint execution section 7D is a circuit section or a process for controlling the reprint of the print data when reprintable print data exists. The reprint herein is performed on the basis of the attachment data recorded together with the main body data.

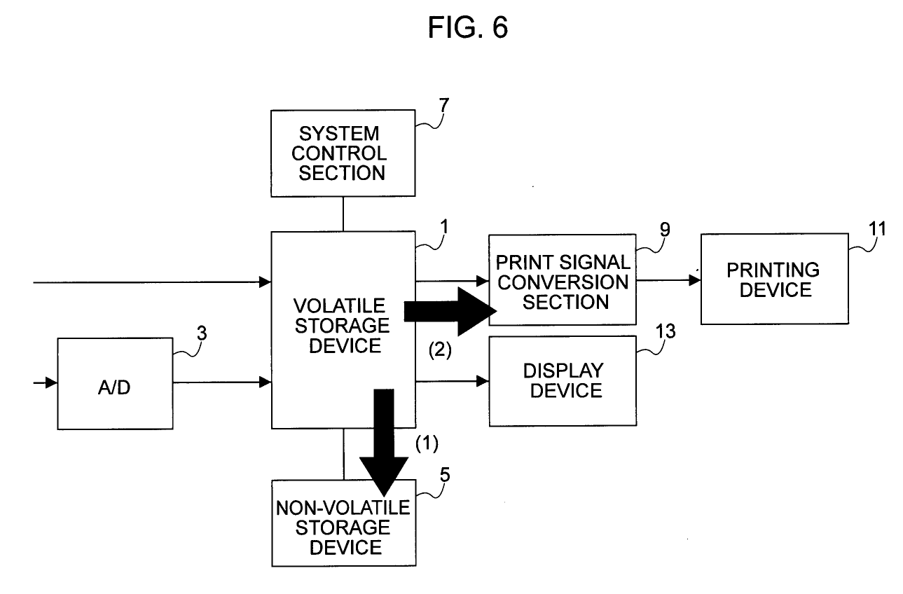

The reprint is performed as a result of the print data stored in the non-volatile storage device 5 being supplied to the printing device 11. At this time, there are two types of methods for reading print data. One is a method for undergoing processes of two stages, as shown in FIG. 6.

In this case, the reprint execution section 7D performs control so that the print data is reproduced from the non-volatile storage device 5 to the volatile storage device 1, and thereafter, the print data is read from the volatile storage device 1. This control technique is a technique suitable for use in a case in which the reading speed of the non-volatile storage device 5 is slower than that of the volatile storage device 1.

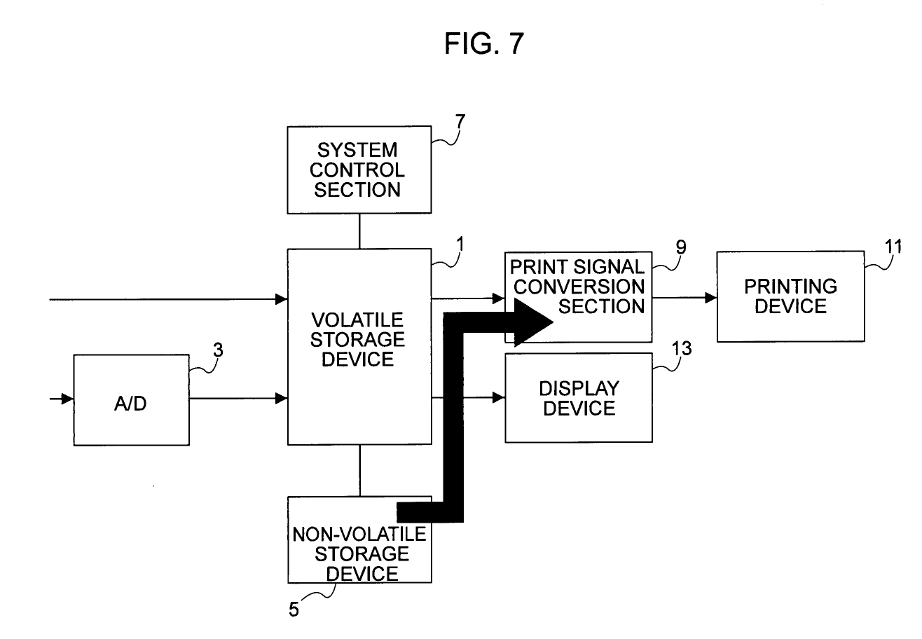

The other method is a method for undergoing a process of one stage, as shown in FIG. 7. In this case, the reprint execution section 7D performs control so that the print data is directly read from the non-volatile storage device 5. This control technique is a technique suitable for use in a case in which the reading speed of the non-volatile storage device 5 is equal to that of the volatile storage device 1.

After the reprint is performed, the print data may be erased from the non-volatile storage device 5 or may be stored as is.

(C-2) Data Conversion Function in Preparation for Secondary Use

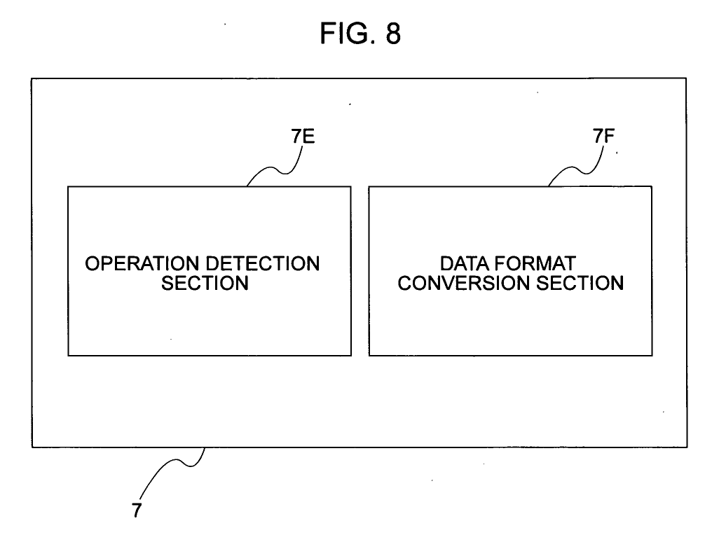

FIG. 8 shows the function block structure of the system control section 7 corresponding to the data conversion function in preparation for secondary use. The system control section 7 realizing this function can be represented as two function blocks of an operation detection section 7E and a data format conversion section 7F. The operation detection section 7E is the same as the operation detection section 7A used for the backup processing function. The operation detection section 7E is implemented as a circuit section or a process for detecting a printing operation for instructing that a printing be performed.

The data format conversion section 7F is realized as a circuit section or a process for converting print data of the volatile storage device 1, which is specified so as to be printed, into an image data format suitable for display on the display device by using the detection of a printing operation as a trigger. In this conversion process, for example, a process for converting the pixel aspect ratio of the print data into a pixel aspect ratio of the display device is performed.

This function enables print data that is actually printed, in the middle of being printed, or waiting for being printed, to be displayed on any desired display device at any desired timing. In the case of this example, the print image is displayed on the display device 13 forming the printing apparatus.

The created image data is stored in the volatile storage device 1 and the non-volatile storage device 5. In this example, the image data created at the same time as the execution of the printing is automatically stored in the externally provided non-volatile storage device 5.

As a result of storing the image data in the non-volatile storage device 5, the print image can be confirmed even after the switching off of the power supply occurs. For example, the non-volatile storage device 5 can be used to confirm a print image whose printing process is stopped due to a printing trouble. Furthermore, the non-volatile storage device 5 can also be used for confirmation during a reprinting of the print image that has already been printed.

In particular, when the externally provided non-volatile storage device 5 is used, this is removed from the printing apparatus, and the non-volatile storage device 5 can be used to confirm the print image by another information processing apparatus and another monitor device.

When the created image data is stored in the non-volatile storage device 5, preferably, a compression process is performed in advance. As a result, the storage area of the non-volatile storage device 5 can be effectively used.

Of course, also in this case, the print data conversion process is performed in parallel with the printing operation in the background with respect to the printing operation. Therefore, there is no need for the user to consciously perform the process for conversion into image data suitable for display.

(D) Example of Control Procedure

In the foregoing, the basic processing functions performed in the system control section 7 have been described. Here, an example of a control procedure realized by these functions is described.

(D-1) When a Printing is Performed

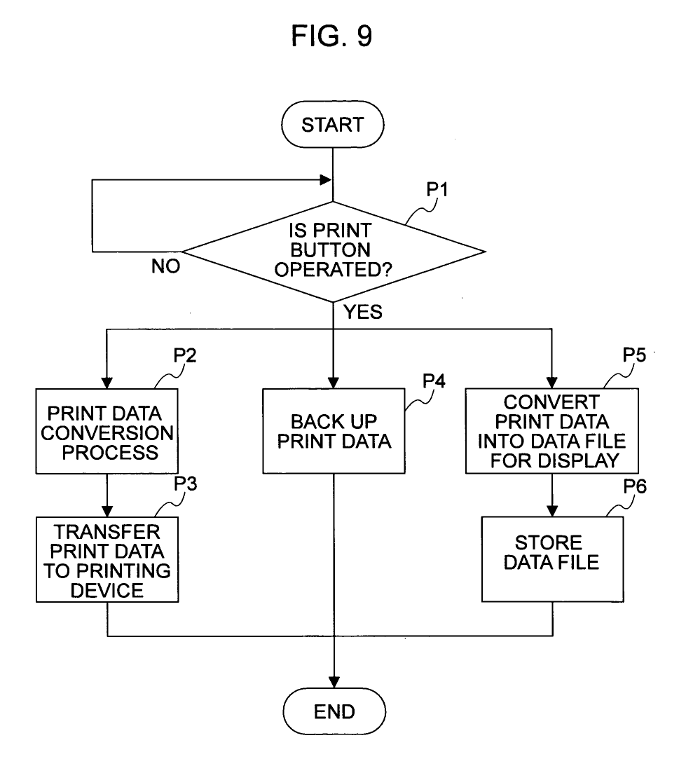

FIG. 9 shows a processing procedure performed when a printing is performed.

Initially, the user operates the print button via the interface. This printing operation is detected by the system control section 7 (process P1).

When the printing operation is detected, the following three processes are performed in parallel with one another.

One of the processes is a printing process (processes P2 and P3). The system control section 7 sequentially reads print data to be printed from the volatile storage device 1 and supplies it to the print signal conversion section 9 (process P2). The print signal conversion section 9 performs signal processing on the print data that is sequentially read and supplies it to the printing device 11 (process P3).

Another one of the processes is a backup process (process P4). The system control section 7 reads the print data from the volatile storage device 1 in parallel with the printing process, and stores it in the non-volatile storage device 5.

The other one of the processes is a data conversion process in preparation for secondary use (processes P5 and P6).

The system control section 7 converts the print data into an image data format suitable for display on the display device in parallel with the printing process (process P5). At this time, a process for compressing the image data is also performed as necessary.

Next, the system control section 7 stores a data file created by the conversion process in the externally provided non-volatile storage device 5 (process P6).

The above three processes are automatically performed by using the operation of the print button as a trigger. For this reason, there is no need for the user to instruct once again the backup of the print data in the non-volatile storage device. Similarly, there is no need for the user to instruct once again a process for converting the print data into a data format suitable for display for confirmation on the display device. That is, it is possible for the user to perform a process that might be necessary in the future by using the print time by only operating the print button.

The data to be stored in the non-volatile storage device 5 is limited to data related to the print image for which the user has actually instructed the execution of a printing. As a result, it is possible to prevent the storage area of the non-volatile storage device 5 from being consumed for a print image having a low necessity.

Since the data file suitable for display on the display device is stored in the non-volatile storage device 5, the print data that is actually used for the printing process can be used for confirmation of the printed result and for confirmation of the image in the middle of being printed. In particular, when a printing is to be performed at a high quality, the print time tends to increase. Therefore, the capability of confirming the print image on the display device in the middle of being printed is convenient.

Furthermore, the data file suitable for display on the display device is stored in the externally provided non-volatile storage device 5.

For this reason, the print image can be confirmed in another electronic device or another monitor device that does not have a function for handling print data.

Of course, not only the printed print data but also the print data waiting for being printed or in the middle of being printed is stored in the non-volatile storage device 5.

For this reason, even when a printing trouble occurs or there occurs a need to print again the same print image for follow-up circumstances, the time taken to restart the printing process and to perform a reprinting can be shortened.

(D-2) When a Reprinting is Performed and When a Trouble is Restored

Here, a description is given of a case in which a print image that has already been printed is to be reprinted or when a printing process is to be restarted when recovering from a trouble.

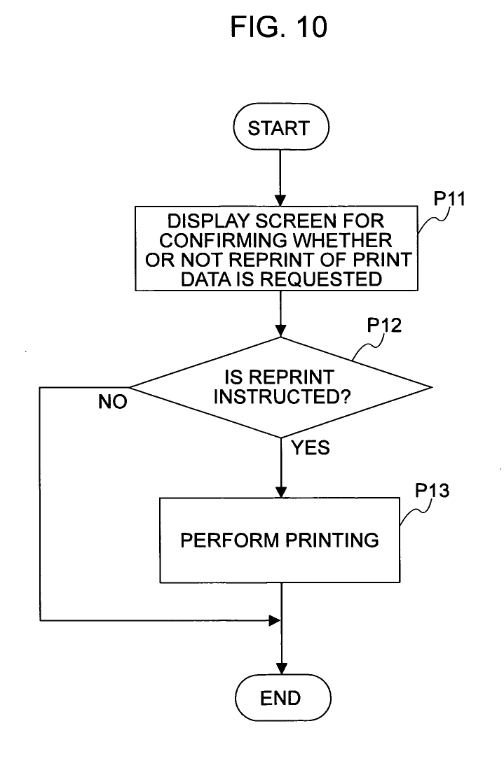

FIG. 10 shows an example of a processing procedure.

For example, when the switching on of the power supply is detected, the system control section 7 allows the display device 13 to display a user interface screen for confirming whether or not there is print data in the middle of being printed or waiting for being printed, which is stored in a non-volatile storage device 14 (process P11).

Also, when a reprinting is input via the user interface, the system control section 7 allows the display device 13 to display a user interface screen for controlling whether or not the execution of a reprinting is requested (process P11).

Next, the system control section 7 determines whether or not the instruction of the user is the execution of a reprinting (process P12). The execution of a reprinting includes the restart of the printing process that is stopped due to an occurrence of a printing trouble and the reprinting of a specific print image.

In the case of this example, in the non-volatile storage device 5, the image data corresponding to the print data specified so as to be printed is stored. Therefore, it is possible for the user to confirm the print image displayed on the display device 13 and to instruct the execution of the reprint.

Here, when the execution of the reprint is instructed, the system control section 7 reads the print data to be printed by one of the above-described methods, and supplies it to the printing device 11 (process P13).

On the other hand, when the stoppage of the printing is instructed, the system control section 7 completes the reprinting process.

As a result of this confirmation screen being provided, the execution of an unnecessary printing process is effectively avoided.

(E) Application Example (Endoscope Diagnostic Device)

Finally, an application example to a video printer connected to a endoscope diagnostic device is described. In this case, a video signal that is output in an analog signal format from an image-capturing camera provided in the front end section of the endoscope is input to the video printer. That is, a live video signal is input.

In the volatile storage device 1 inside the video printer, only still images when a doctor, a nurse, and other medical staff have specified are captured as print information. In the case of this embodiment, in the attachment data of the print information, the name of the patient, the photo-taking date and time, the name of the doctor in charge, and other medical information are contained.

Both the volatile storage device 1 and the non-volatile storage device 5 can capture eight still images. The printing of the video printer is started as a result of the medical staff instructing the printing of the captured still image.

In the case of this video printer, the print data is backed up in the non-volatile storage device 5 from the volatile storage device 1 in parallel with the start of the printing. At the same time, the print data is converted into a data format suitable for display on the display device and is stored in the non-volatile storage device 5.

For this reason, even if a trouble other than that of the signal system occurs during printing and the video printer needs to be reset for the recovery thereof, the printing can be restarted with respect to at least the print image for which the print button is operated. This fact has merits in that, not only can the burden of the patient be reduced, but also the operability of the medical device can be improved.

Of course, even when it is desired to print again the print image of an affected area in a follow-up manner, if the print data is read from the non-volatile storage device 5, a necessary number of print images can be obtained.

In the video printer, the image data corresponding to the print image is stored. Therefore, even when the print image to be reprinted is to be selected, the print image to be printed can be selected while visually confirming the print image on the display device.

This is easier for confirmation when compared to the case in which a selection is made using only the text information, and mistakes become less frequent. As a result, the operation burdens are reduced, and the operation efficiency is improved.

If the storage medium used in the non-volatile storage device 5 is a semiconductor memory loadable into and removable from the video printer, even if it may be impossible to restart the printing by the video printer in which a trouble has occurred, the printing process can be restarted while the information of the attachment data is being maintained (under the same conditions) by loading the target semiconductor memory into another video printer.

As described above, as a result of both the main body data and the attachment data being stored at the same time, the same print quality can be reproduced regardless of the differences in the video printers. The effects of using a removable storage device are common with other embodiments. Furthermore, as long as there is no problem in the communication function, print signals (main body data and attachment data) can be externally read from the non-volatile storage device incorporated in the printing apparatus.

(F) Other Embodiments

(a) In the above-described embodiment, a process for backing up print data and a process for converting print data are performed in parallel with the printing process.

However, these processes may be performed by using a free time after the reading of the print data into the printing device is completed.

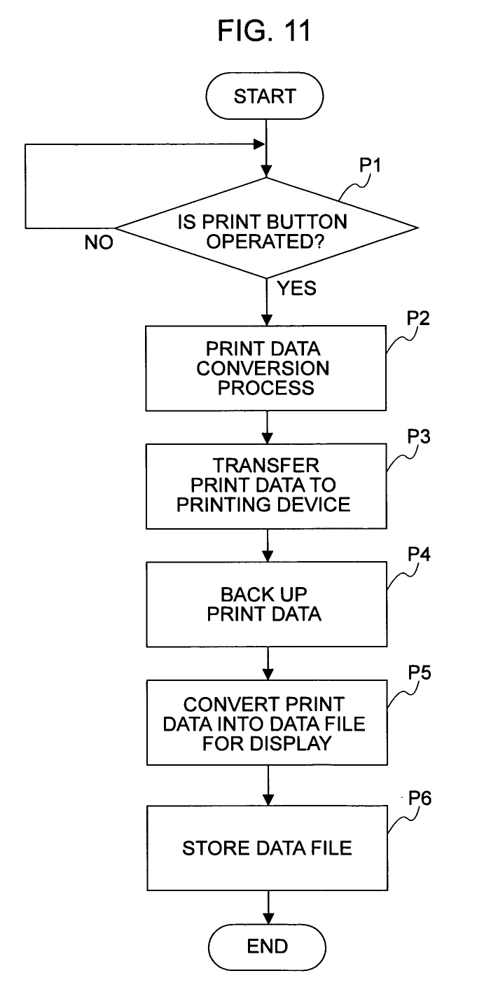

FIG. 11 shows an example of the control procedure. In order to omit descriptions thereof, processes in FIG. 11 that are the same as those in FIG. 9 are designated with the same reference numerals. In FIG. 11, following the printing process (processes P2 and P3), a backup process (process P4) is performed, and thereafter, a data conversion process (processes P5 and P6) is performed.

(b) In the above-described embodiment, a print data backup process and a data conversion process are performed in parallel with the printing process. However, for a process to be performed in parallel with the printing process, one of the backup process and the data conversion process may be performed, and the remaining process may be performed after the two processes are completed.

Furthermore, a technique may also be adopted in which, although the backup process and the data conversion process are performed in parallel with the printing process, one of the backup process and the data conversion process is performed earlier, and the other process is performed after the previously performed process is completed.

(c) In the above-described embodiment, both the backup process and the data conversion process are installed in the printing apparatus. However, a mechanism in which one of them is installed in the printing apparatus may be adopted. Furthermore, a mechanism in which, although the two processing functions are installed, only one of them is automatically performed in synchronization with the operation of the print button via a user interface may be adopted.

(d) In the above-described embodiment, a case is described in which the backup target of the print data is set to the built-in non-volatile storage device 5, and the target where the data file created in the data conversion process is set to the externally provided non-volatile storage device 5.

However, when the non-volatile storage device 5 that can be used is limited to only one of the built-in and externally provided devices, print data and data files should be recorded in the non-volatile storage device 5 that can be used.

(e) In the above-described embodiments, various modifications are possible within the spirit and scope of the present invention. Furthermore, various modifications and application examples created on the basis of the description of this specification are possible.

What is claimed is:

1. A printing apparatus comprising:
a volatile storage device temporarily storing print data;
a printing device recording a print image corresponding to the print data on a recording medium;
an operation detection section detecting a printing operation for instructing that a printing be performed; and
a reproduction control section reproducing print data specified so as to be printed from the volatile storage device to a built-in or externally provided non-volatile storage device by using a detection of the printing operation as a trigger.

2. The printing apparatus according to claim 1, wherein the reproduction control section performs a reproduction operation in parallel with a reading of print data into the printing device.

3. The printing apparatus according to claim 1, wherein the reproduction control section performs a reproduction operation by using a free time after a reading of print data into the printing device is completed.

4. The printing apparatus according to claim 1, wherein the reproduction control section reproduces the print data and also attachment data thereof.

5. The printing apparatus according to claim 1, wherein the print data is given such that a video signal specified so as to be printed within a video signal that is input in an analog signal format is converted into a digital signal format.

6. The printing apparatus according to claim 1, wherein the print data is given in a digital signal format.

7. The printing apparatus according to claim 1, further comprising a data format conversion section converting print data into an image data format suitable for display on a display device by using a detection of the printing operation as a trigger.

8. A printing apparatus comprising:
a volatile storage device temporarily storing print data;
a printing device recording a print image corresponding to the print data on a recording medium;
an operation detection section detecting a printing operation for instructing that a printing be performed; and
a data format conversion section converting print data specified so as to be printed into an image data format suitable for display on a display device by using a detection of the printing operation as a trigger.

9. The printing apparatus according to claim 8, further comprising a storage control section storing print data converted into an image data format suitable for display on a display device in the non-volatile storage device.

10. A data backup method for use with a printing apparatus including a volatile storage device temporarily storing print data; and a printing device recording a print image corresponding to the print data on a recording medium, the data backup method comprising the steps of:
detecting a printing operation for instructing that a printing be performed; and
reproducing print data specified so as to be printed from the volatile storage device to a built-in or externally provided non-volatile storage device by using a detection of the printing operation as a trigger.

11. A data backup method for use with a printing apparatus including a volatile storage device temporarily storing print data; and a printing device recording a print image corresponding to the print data on a recording medium, the data backup method comprising the steps of:
detecting a printing operation for instructing that a printing be performed; and
converting print data specified so as to be printed into an image data format suitable for display on a display device by using a detection of the printing operation as a trigger.

12. A program for enabling a computer for controlling a printing apparatus including a volatile storage device temporarily storing print data; and a printing device recording a print image corresponding to the print data on a recording medium to perform processing comprising the steps of:
detecting a printing operation for instructing that a printing be performed; and
reproducing print data specified so as to be printed from the volatile storage device to a built-in or externally provided non-volatile storage device by using a detection of the printing operation as a trigger.

13. A program for enabling a computer for controlling a printing apparatus including a volatile storage device temporarily storing print data; and a printing device recording a print image corresponding to the print data on a recording medium to perform processing comprising the steps of:
detecting a printing operation for instructing that a printing be performed; and
converting print data specified so as to be printed into an image data format suitable for display on a display device by using a detection of the printing operation as a trigger.
